(19) United States
(12) Patent Application Publication
(10) Pub. No.: US 2025/0172914 A1
(43) Pub. Date: May 29, 2025

(54) Data Mining on an Edge Platform Using Repurposed Neural Network Models in Autonomous Systems

(71) Applicant: GM CRUISE HOLIDINGS LLC, SAN FRANCISCO, CA (US)

(72) Inventor: Matthew Elkherj, Belmont, CA (US)

(73) Assignee: GM CRUISE HOLDINGS LLC, SAN FRANCISCO, CA (US)

(21) Appl. No.: 18/520,241

(22) Filed: Nov. 27, 2023

(51) Int. Cl. G05B 13/02; B60W 50/00; B60W 60/00

(52) U.S. Cl. CPC G05B 13/027; B60W 50/0098; B60W 60/001

(57) ABSTRACT

Disclosed are embodiments for facilitating data mining on an edge platform using repurposed neural network models in autonomous systems. In some aspects, an embodiment includes receiving, by a processing device hosting a data source proxy head of a machine learning (ML) model deployed on an autonomous vehicle (AV), a set of features selected from raw data by a backbone network of the ML model; utilizing, by the data source proxy head, the set of features selected from the raw data as input data to a trained data source mining model of the data source proxy head; identifying, by the trained data source mining model based on the input data, a portion of the raw data to classify as mining data; and providing, by the data source proxy head, identification of the portion of the raw data as a data mining output.

### BACKGROUND

### 1. Technical Field

The disclosure generally relates to the field of processing systems and, more specifically, to data mining on an edge platform using repurposed neural network models in autonomous systems.

### 2. Introduction

Autonomous vehicles, also known as self-driving cars, driverless vehicles, and robotic vehicles, may be vehicles that use multiple sensors to sense the environment and move without a human driver. An example autonomous vehicle can include various sensors, such as a camera sensor, a light detection and ranging (LIDAR) sensor, and a radio detection and ranging (RADAR) sensor, amongst others. The sensors collect data and measurements that the autonomous vehicle can use for operations such as navigation. The sensors can provide the data and measurements to an internal computing system of the autonomous vehicle, which can use the data and measurements to control a mechanical system of the autonomous vehicle, such as a vehicle propulsion system, a braking system, or a steering system.

### BRIEF DESCRIPTION OF THE DRAWINGS

The various advantages and features of the disclosed technology will become apparent by reference to specific embodiments illustrated in the appended drawings. A person of ordinary skill in the art will understand that these drawings show some examples of the disclosed technology and would not limit the scope of the disclosed technology to these examples. Furthermore, the skilled artisan will appreciate the principles of the disclosed technology as described and explained with additional specificity and detail through the use of the accompanying drawings in which:

FIG. 1 is a block diagram illustrating an example system for data mining on an edge platform using repurposed neural network models in autonomous systems, in accordance with embodiments herein;

FIG. 2 is a block diagram of an autonomous vehicle (AV) system implementing a data source proxy head that utilizes a machine learning (ML) model backbone network of a deployed ML model on an AV, in accordance with embodiments herein;

FIG. 3 is a block diagram of an AV system implementing a data mining model that receives features of a deployed ML model on an AV, in accordance with embodiments herein;

FIG. 4 illustrates an example method implementing data mining on an edge platform using a data source proxy head attached to an ML model of the AV, in accordance with embodiments herein;

FIG. 5 illustrates an example method for data mining on an edge platform using a dedicated data mining model deployed on the AV that consumes features from another ML model on the AV, in accordance with embodiments herein;

FIG. 6 illustrates an example system environment that can be used to facilitate AV dispatch and operations, according to some aspects of the disclosed technology;

FIG. 7 illustrates an example of a deep learning neural network that can be used to implement a perception module and/or one or more validation modules, according to some aspects of the disclosed technology; and

FIG. 8 illustrates an example processor-based system with which some aspects of the subject technology can be implemented.

### DETAILED DESCRIPTION

The detailed description set forth below is intended as a description of various configurations of the subject technology and is not intended to represent the configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

Autonomous vehicles (AVs), also known as self-driving cars, driverless vehicles, and robotic vehicles, can be implemented by companies to provide self-driving car services for the public, such as taxi or ride-hailing (e.g., ridesharing) services. The AV can navigate about roadways without a human driver based upon sensor signals output by sensor systems deployed on the AV. AVs may utilize multiple sensors to sense the environment and move without a human driver. An example AV can include various sensors, such as a camera sensor, a light detection and ranging (LIDAR) sensor, and a radio detection and ranging (RADAR) sensor, amongst others. The sensors collect data and measurements that the autonomous vehicle can use for operations such as navigation. The sensors can provide the data and measurements to an internal computing system of the autonomous vehicle, which can use the data and measurements to control a mechanical system of the autonomous vehicle, such as a vehicle propulsion system, a braking system, or a steering system.

AVs can utilize one or more trained machine learning (ML)-based models that autonomously control and/or operate the vehicle. The trained model(s) can utilize the data and measurements captured by the sensors of the AV to identify, classify, and/or track objects (e.g., vehicles, people, stationary objects, structures, animals, etc.) within the AV's environment. The model(s) utilized by the AV may be trained using any of various suitable types of learning, such as deep learning (also known as deep structured learning). Deep learning is part of a broader family of machine learning methods based on artificial neural networks with representation learning. The learning can be supervised, semi-supervised, or unsupervised, and may be trained using real-world image data and/or image data generated in a simulated environment that have been labeled according to “correct” outputs of one or more perception functions (e.g., segmentation, classification, and/or tracking) of the AV.

Generating a robust and accurate training data set for training ML-based models can directly impact the effectiveness and accuracy of those trained models when utilized in the AV. One aspect of generating a robust and accurate training data set is being able to identify and include in the training data set rare cases that can be used to train out the ML-based models. Data mining techniques can be utilized to identify those “rare cases”. Data mining is a term used to describe the process of sorting through large data sets to identify data having certain characteristics. Some approaches to data mining in autonomous system fields, such as in the field of data mining for ML models deployed on AVs, may encounter problems. One problem is that the data mining techniques may not be able to be run everywhere. For example, some SQL/attribute store miners are not run in the AV, are not run in simulation, and are cost-prohibitive to be run on the entirety of road data collected from operating AVs. Other types of data mining techniques utilize manual human interaction to tune and maintain data miners, which is a highly-laborious process.

Embodiments herein address the above-noted problems experienced with data mining in autonomous systems by providing data mining on an edge platform using repurposed neural network models in autonomous systems. In one example, an edge platform of an autonomous system can include an AV. An edge platform may refer to processing capabilities closer to the end user/device/source of data, on physical compute infrastructure that is positioned on the spectrum between the device and the internet/server/cloud. Edge platforms may further refer to platforms as a software environment that is used to write and run software applications. In embodiments herein, a miner head, which may be referred to as a data source proxy head herein, is added to an ML model running on the AV. The ML model running on the AV may be a previously-deployed ML model on the AV, such as a trajectory generation model, a perception model, etc. A head in an ML model may refer to the top (or output) layer(s) of the neural network of the ML model. The backbone network (or backbone) of the ML model may refer to the remaining layers of the ML model that receive input data and extracts features from the input data (e.g., series of convolutional and pooling layers). In some cases, an ML model may have multiple heads, referred to as a multi-head model.

The data source proxy head of embodiments herein is configured to run online on the AV while the AV is operating in order to identify and collect data that the data source proxy head is trained to identify as relevant for data mining purposes. In embodiments herein, the intermediate computations and data that are performed and generated by the ML model (e.g., trajectory generation models, perception models, etc.) deployed on the AV can be utilized (e.g., re-used) by attaching the lightweight data source proxy head to the ML model to trigger selective data collection from the AV. In some embodiments, the data source proxy head may be a lightweight classifier. In this way, features captured by the ML models already operating on the AV can be repurposed and utilized for data mining purposes. In some embodiments, there may be multiple data source proxy heads to capture different scenarios that are sought for data mining purposes.

Embodiments herein may implement the data source proxy head using a variety of different approaches. In one embodiment, the data source proxy head may be deployed as a model head on top of a backbone network of an existing ML model deployed in the AV. In this approach, the data source proxy head may be trained using different approaches, as described further herein. In another embodiment, the data source proxy head may be deployed as its own lightweight dedicated model on the AV, but is configured to consume the same features as an existing ML model already deployed on the AV.

Embodiments herein provide for a data source proxy head that can run on the edge (edge platform) anywhere that a base ML model is running that includes source mining data sought after for mining purposes. This data source proxy head can re-use existing ML model infrastructure and computations, resulting in reduced computational demands on compute resources of the AV.

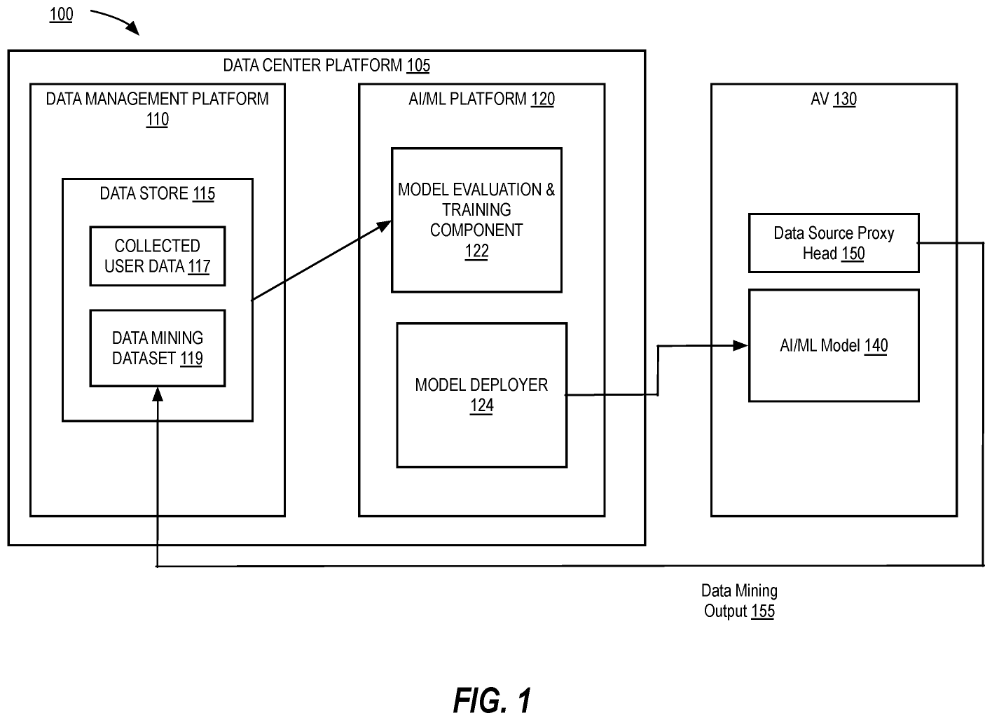

Although some embodiments herein are described as operating in an AV, other embodiments may be implemented in an environment that is not an AV, such as, for example, other types of vehicles (human operated, driver-assisted vehicles, etc.), air and terrestrial traffic control, radar astronomy, air-defense systems, anti-missile systems, marine radars to locate landmarks and other ships, aircraft anti-collision systems, ocean surveillance systems, outer space surveillance and rendezvous systems, meteorological precipitation monitoring, altimetry and flight control systems, guided missile target locating systems, ground-penetrating radar for geological observations, and so on. Furthermore, other embodiments may be more generally implemented in any artificial intelligence and/or machine learning-type environment. The following description discusses embodiments as implemented in an automotive environment, but one skilled in the art will appreciate that embodiments may be implemented in a variety of different environments and use cases. Further details of the real-time AV fleet parking availability of embodiments herein are further described below with respect to FIGS. 1-8.

FIG. 1 is a block diagram illustrating an example system 100 for data mining on an edge platform using repurposed neural network models in autonomous systems, in accordance with embodiments herein. In one embodiment, system 100 implements a data center platform 105 communicably coupled to an AV 130 for providing the data mining on an edge platform using repurposed neural network models in autonomous systems, as described further herein. The data center platform 105 of FIG. 1 can be, for example, part of a data center that is cloud-based or otherwise. In other examples, the AV 130 can be part of an AV or a human-operated vehicle having an advanced driver assistance system (ADAS) that can utilize various sensors including radar sensors.

In one embodiment, system 100 can communicate over one or more networks (not shown), such as a public network (e.g., the Internet, an Infrastructure as a Service (IaaS) network, a Platform as a Service (PaaS) network, a Software as a Service (SaaS) network, another Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.). In one embodiment, system 100 can be implemented using a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and so forth.

The system 100 may be part of a platform for managing a fleet of AVs and AV-related services. The platform can include the data center platform 105, which can send and receive various signals to and from an AV 130. These signals can include sensor data captured by the sensor systems of the AV 130, roadside assistance requests, software updates, ridesharing pick-up and drop-off instructions, and so forth. In some examples, the data center platform 105 may also support a ridesharing service, a delivery service, a remote/roadside assistance service, street services (e.g., street mapping, street patrol, street cleaning, street metering, parking reservation, etc.), and the like. In some embodiments, the system 100 may be implemented in the AV itself or may be implemented in a server computing device.

In this example, the system 100 includes a data center platform 105 hosting one or more of a data management platform 110 and an Artificial Intelligence/Machine Learning (AI/ML) platform 120, among other systems, that are communicably coupled to an AV 130.

Data management platform 110 can be a “big data” system capable of receiving and transmitting data at high speeds (e.g., near real-time or real-time), processing a large variety of data, and storing large volumes of data (e.g., terabytes, petabytes, or more of data). The varieties of data can include data having different structures (e.g., structured, semi-structured, unstructured, etc.), data of different types (e.g., sensor data, mechanical system data, ridesharing service data, map data, audio data, video data, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. In one embodiment, the data management platform includes a data store 115 that stores collected user data 117 collected, for example, from the user (e.g., as part of setting up a user profile) and/or from operation of one or more AVs. In some embodiments, data store 115 may also include a data mining dataset 119 that stores data that is mined for use in training and/or evaluation of ML models.

The AI/ML platform 120 can provide an infrastructure for training and evaluating machine learning algorithms for operating the AV, and other platforms and systems. In one embodiment, the AI/ML platform 120 of system 100 may include a model evaluation and training component 122, and/or a model deployer 124. Using the model evaluation and training component 122, and/or the model deployer 124, data scientists can prepare data sets from the data management platform 110; select, design, and train machine learning models 140; evaluate, refine, and deploy the models 140; maintain, monitor, and retrain the models 140; and so on.

In embodiments herein and as previously discussed, as part of the training and evaluation of ML algorithms for operating the AV, a robust and accurate training data set should be utilized. One aspect of generating a robust and accurate training data set is being able to identify and include in the training data set rare cases that can be used to train out the ML-based models. Data mining techniques can be utilized to identify those “rare cases”. Different approaches to identifying and collecting those rare and interesting cases may be implemented in autonomous systems.

Embodiments herein provide for data mining on an edge platform, such as AV 130, by re-using infrastructure and computations of existing AI/ML model(s) 140 deployed on the AV 130. In embodiments herein, a data source proxy head 150 may be deployed on the AV 130. The data source proxy head 150 can be configured to utilize the infrastructure and/or computation of an existing ML model 140 deployed on the AV 130. In one embodiment, the ML model 140 running on the AV 130 may be a previously-deployed ML model, such as a trajectory generation model, a perception model, and so on.

The data source proxy head 150 may refer to the top (or output) layer(s) of the neural network of the ML model 140. A backbone network (or backbone) of the ML model 140 may refer to the remaining layers of the ML model 140 that receive input data and extracts features from the input data (e.g., series of convolutional and pooling layers). The data source proxy head 150 of embodiments herein is configured to run online on the AV 130 while the AV 130 is operating in order to identify and collect data that the data source proxy head is trained to identify as relevant for data mining purposes. In embodiments herein, the intermediate computations and data that are performed and generated by the existing ML model 140 can be utilized (e.g., re-used) by attaching the data source proxy head 150 to the ML model 140 to trigger selective data collection from the AV. In some embodiments, the data source proxy head may be a lightweight classifier. In this way, features captured by the existing ML models 140 already operating on the AV 130 can be repurposed and utilized for data mining purposes. In some cases, the ML model 140 may have multiple data source proxy heads 150, each seeking to identify different scenarios occurring in the input data.

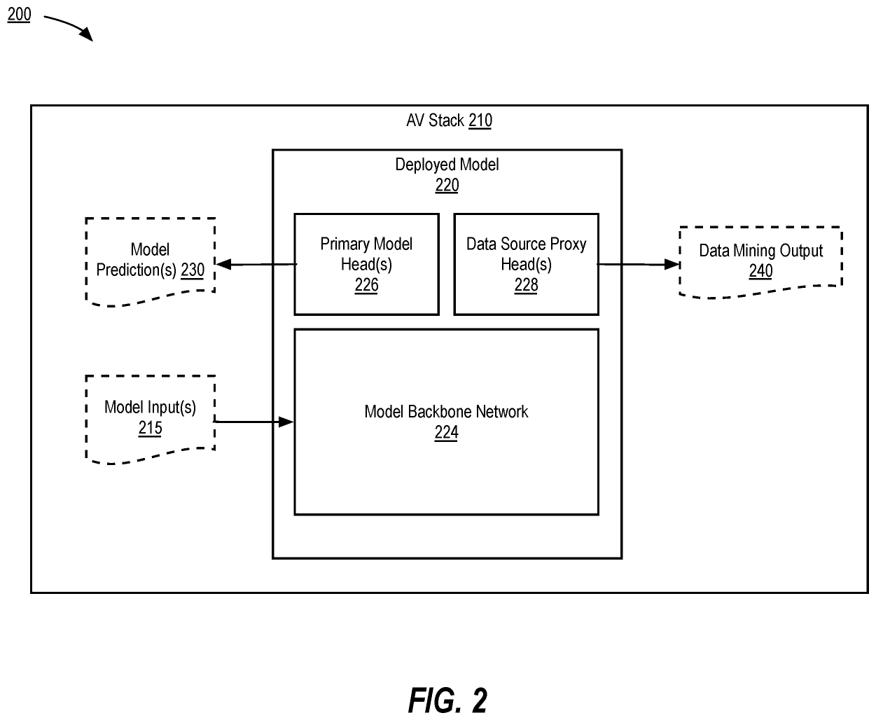

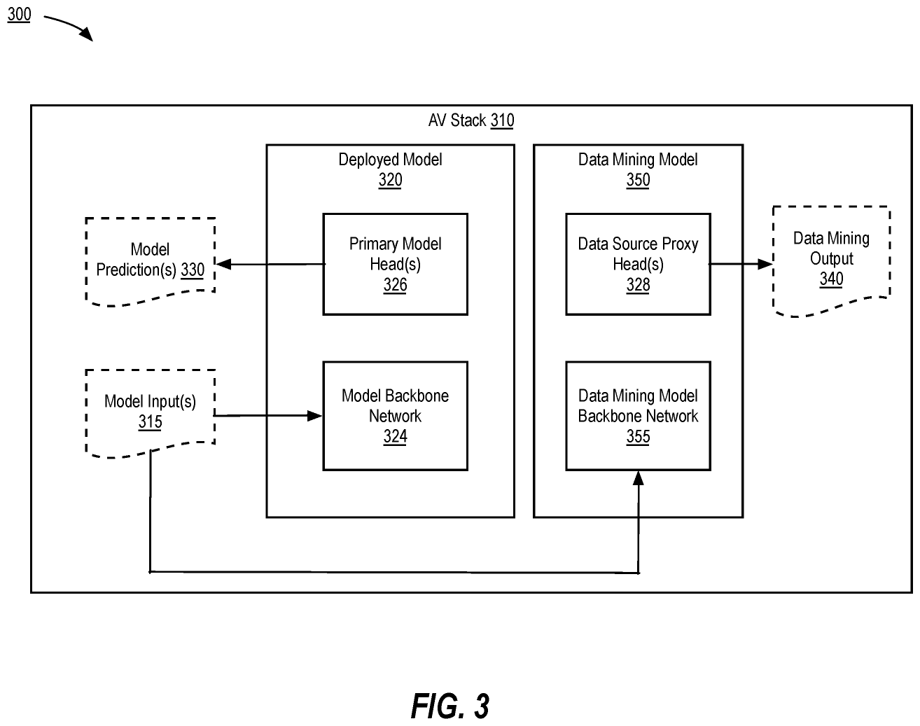

Embodiments herein may implement the data source proxy head using a variety of different approaches. In one embodiment, described further below with respect to FIG. 2, the data source proxy head may be deployed as a model head on top of a backbone network of an existing ML model deployed in the AV. In this approach, the data source proxy head may be trained using different approaches, as described further herein. In another embodiment, described further below with respect to FIG. 3, the data source proxy head may be deployed as its own lightweight dedicated model on the AV, but is configured to consume the same features as an existing ML model already deployed on the AV.

In some embodiments, once the data source proxy head 150 has identified input data to be collected (as data mining output 155), a logging infrastructure of the AV 130 may collect input data occurring during a determined time period (e.g., +/−30 seconds) around the triggering event. This collected data may be provided to the data center platform 105 (e.g., in data management platform 110) to include in data mining dataset 119 for purposes of ML model training and/or evaluation by model evaluation and training component 122 of AI/ML platform 120. Further details of the data mining on an edge platform using repurposed neural network models in autonomous systems are provided below with respect to FIGS. 2-8.

FIG. 2 is a block diagram of an AV system 200 implementing a data source proxy head that utilizes an ML model backbone network of a deployed ML model on an AV, in accordance with embodiments herein. In one embodiment, AV system 200 is the same as AV 130 described with respect to FIG. 1. AV system 200 may include an AV stack 210. AV stack 210 can include components and processes to enable and support decision making in the AV operations in terms of routing, planning, sensing, maneuvering, operating, and so on. The AV stack 210 can include, among other stacks (sub-stacks) and systems, a perception stack, a localization stack, a planning stack, a control stack, a communications stack, a High Definition (HD) geospatial database, or an AV operational database, for example.

AV stack 210 may include one or more deployed models 220. The deployed model 220 may be an ML model hosted by one or more of the sub-stacks of AV stack 210. For example, deployed model 220 may be a trajectory planning model, a perception model, a localization model, and so on. In some embodiments, deployed model 220 may be an ML model capable of performing an aggregation of AV tasks on the AV.

In one embodiment, deployed model 220 may include a model backbone network 224, primary model head(s) 226, and data source proxy head(s) 228. The model backbone network 224 receives model inputs 315 and processes the raw data of the model input(s) 215 to create intermediate embedding representations that can be passed to downstream portions of the model backbone network 224. A feature may refer to the independent variables in ML models that are learned by the ML model. Feature can be in the form of raw data or data in its original form, or may have to be represented or encoded in different forms. For example, a color can be represented in RGB or HSV format.

Model backbone network 224 (also referred to herein as model backbone or backbone network) may refer to the core architecture or structure of the deployed model 220. The model backbone network 224 is the underlying framework that supports the learning process and enables the network to create the intermediate embedding representations from the input data, such as model inputs 215. These intermediate embedding representations generated by the model backbone network 224 are then passed to multiple heads 226, 228 of the deployed model 220.

The deployed model 220 may include one or more primary model heads 226 which perform the specific tasks of the deployed model 220. For example, if deployed model 220 is a trajectory generation model, the primary model head(s) 226 may perform the operations on the feature representations extracted by model backbone network 224 to generate a set of possible trajectories for the AV. In one embodiment, the primary model head(s) 226 can generate the model prediction(s) 230 of the deployed model 220.

In embodiments herein, a data source proxy head 228 may also be attached to the deployed model 220 for use in online (e.g., on the operating AV) data mining related to the deployed model 220. The data source proxy head(s) 228 identifies and causes logging of raw input data that the data source proxy head identifies as relevant for data mining purposes. In some embodiments, the data source proxy head may be a classifier model. In some cases, the deployed model 220 may have multiple data source proxy heads 228, each data source proxy head 228 trained to identify a different scenario in the input data that is useful for data mining purposes (e.g., used for training ML models (such as the deployed model 220) and/or for evaluation of ML models (such as the deployed model 220)). In some embodiments, a data source proxy head 228 may be trained to identify a more generalized scenario that is useful for training and/or evaluation, such as identifying potential takeover situations of the AV (i.e., takeover by a human driver).

Training of the data source proxy head(s) 228 may utilize data mining labels. These data mining labels may be sourced from one or more other existing data miner sources (hence the “proxy” of embodiments herein). In this case, each deployed model 220 may have a data source field available at training time. This field may capture which data miner generated the training/test example. In this case, the deployed data source proxy head(s) 228 may bootstrap the labels utilized by those identified data miner sources as its own labels for training purposes. In some cases, training quality of the data source proxy head(s) 228 can also be improved by leveraging human-generated labels as well.

Embodiments herein may train the data source proxy head(s) 228 using a variety of different approaches. In one example embodiment, the data source proxy head 228 may be trained using a competing heads approach. In this case, the heads of the deployed model 220, including the primary model head(s) 226 and the data source proxy head(s) are trained and optimized at the same time, with loss from the head(s) 226, 228 being back propagated through the model backbone network 224. In some embodiments, to avoid deployed model 220 quality degradation, a loss weight of the data source proxy head(s) 228 may be kept low enough that no deployed model 220 performance degradation is observed. This may be referred to herein as mitigating regression of the deployed model 220.

In another example embodiment, the data source proxy head 228 may be trained using a frozen embeddings approach. In this case, the data source proxy head(s)′ 228 loss back propagation through the model backbone network 224 is cut off. This is referred to as a frozen embeddings approach because the trained embeddings (e.g., weights and/or parameters) of the model backbone network 224 are kept in place (“frozen”) after initial training of the primary model head(s) 226. Subsequently, the data source proxy head(s) 228 are trained on top of this frozen model backbone network 224.

In some embodiments, the data source proxy head(s) 228 can identify the portions of model input 215 to be collected and output as data mining output 240. In one embodiment, a logging infrastructure of the AV may utilize the data mining output 240 to collect raw data occurring during a determined time period (e.g., +/−30 seconds) around the data mining output 240. This collected raw data may be provided to the data center platform 105 (e.g., in data management platform 110) to include in a data mining dataset for purposes of ML model training and/or model evaluation, as previously discussed.

FIG. 3 is a block diagram of an AV system 300 implementing a data mining model that receives features of a deployed ML model on an AV, in accordance with embodiments herein. In one embodiment, AV system 300 is the same as AV 130 described with respect to FIG. 1. AV system 300 may include an AV stack 310. AV stack 310 can include components and processes to enable and support decision making in the AV operations in terms of routing, planning, sensing, maneuvering, operating, and so on. The AV stack 310 can include, among other stacks (sub-stacks) and systems, a perception stack, a localization stack, a planning stack, a control stack, a communications stack, a High Definition (HD) geospatial database, or an AV operational database, for example.

AV stack 310 may include one or more deployed models 320, and a data mining model 350. The deployed model 320 may be an ML model hosted by one or more of the sub-stacks of AV stack 310. For example, deployed model 320 may be a trajectory planning model, a perception model, a localization model, and so on. In some embodiments, deployed model 320 may be an ML model capable of performing an aggregation of AV tasks on the AV.

In one embodiment, deployed model 320 may include a model backbone network 324 and primary model head(s) 326. The data mining model 350 may include a data mining model backbone network 355 and data source proxy head(s) 328.

The model backbone network 324 and the data mining model backbone network 355 both receive model inputs 315 and process the raw data of the model inputs 315 to create intermediate embedding representations that can be passed to downstream portions of the deployed model 320 and the data mining model 350, respectively. In embodiments herein, the data mining model 350 may be a small, dedicated model deployed on the AV that consumes the same features as the deployed model 320.

Model backbone network 324 may refer to the core architecture or structure of the deployed model 320. The model backbone network 324 is the underlying framework that supports the learning process and enables the network to extract the meaningful selected features from the input data. In other words, the model backbone network 324 may refer to the feature-extracting network that processes input data into a certain feature representation. These feature representations generated by the model backbone network 324 are passed to the primary model head(s) 326 of the deployed model 320.

Similarly, the data mining model backbone network 355 may refer to the feature-extracting network that processes input data into a certain feature representation for the data mining model 350. The feature representations generated by the data mining model backbone network 355 are passed to the data source proxy head(s) 328 of the data mining model 350.

The deployed model 320 may include one or more primary model heads 326 which perform the specific tasks of the deployed model 320. For example, if deployed model 320 is a trajectory generation model, the primary model head(s) 326 may perform the operations on the feature representations extracted by model backbone network 324 to generate a set of possible trajectories for the AV. In one embodiment, the primary model head(s) 326 can generate the model prediction(s) 330 of the deployed model 320.

In embodiments herein, the data source proxy head(s) 328 may operate on the AV to identify data mining output 340. The data source proxy head(s) 328 can identify data mining events and cause logging of raw input data that the data source proxy head identifies as relevant for data mining purposes. In some embodiments, the data source proxy head(s) 328 may be a classifier model. In some cases, there may be multiple data source proxy heads 328, where each data source proxy head 328 is trained to identify a different scenario in the input data that is useful for data mining purposes. In some embodiments, a data source proxy head 328 may be trained to identify a more generalized scenario that is useful for training and/or evaluation, such as identifying potential takeover situations of the AV (i.e., takeover by a human driver).

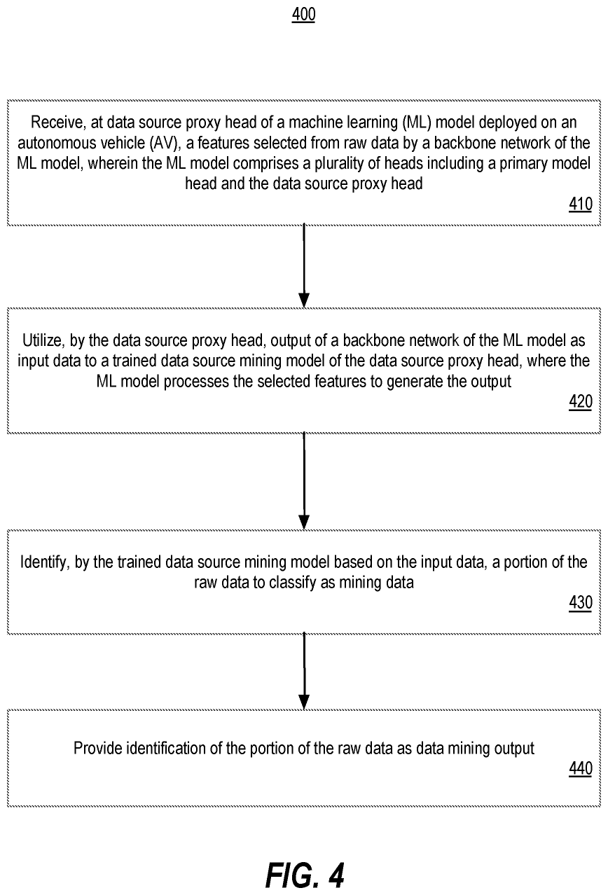

FIG. 4 illustrates an example method 400 implementing data mining on an edge platform using a data source proxy head attached to an ML model of the AV, in accordance with embodiments herein. Although the example method 400 depicts a particular sequence of operations, the sequence may be altered without departing from the scope of the disclosure. For example, some of the operations depicted may be performed in parallel or in a different sequence that does not materially affect the function of the method 400. In other examples, different components of an example device or system that implements the method 400 may perform functions at substantially the same time or in a specific sequence.

According to some embodiments, the method 400 includes block 410 where a data source proxy head of an ML model deployed on an AV receives features selected from raw data by a backbone network of the ML model. In one embodiment, the ML model includes a plurality of heads including a primary model head and the data source proxy head. Then, at block 420, the data source proxy head utilizes output of a backbone network of the ML model as input data to a trained data source mining model of the data source proxy head. In one embodiment, the ML model processes the selected features to generate the output.

Subsequently, at block 430, the trained data source mining model identifies, based on the input data, a portion of the raw data to classify as mining data. Lastly, at block 440, identification of the portion of the raw data is provided as a data mining output.

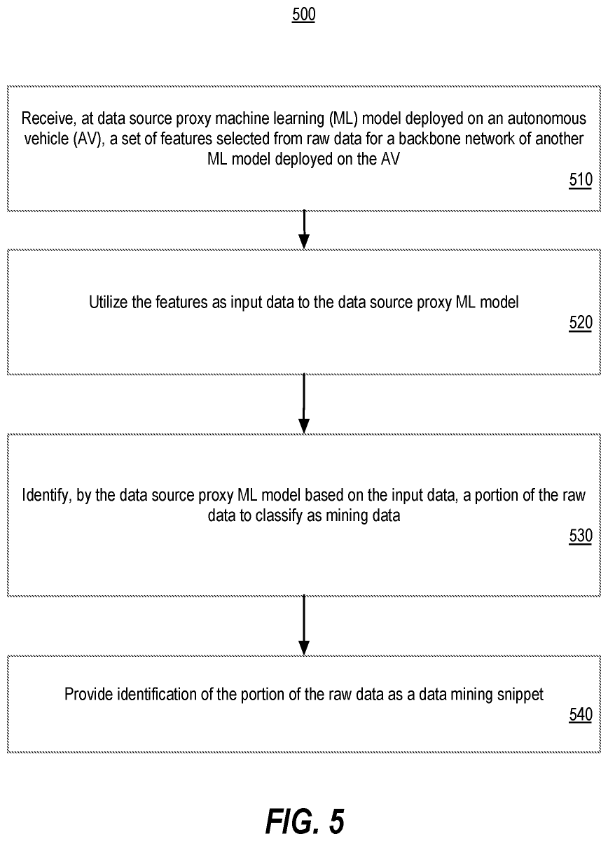

FIG. 5 illustrates an example method 500 for data mining on an edge platform using a dedicated data mining model deployed on the AV that consumes features from another ML model on the AV, in accordance with embodiments herein. Although the example method 500 depicts a particular sequence of operations, the sequence may be altered without departing from the scope of the disclosure. For example, some of the operations depicted may be performed in parallel or in a different sequence that does not materially affect the function of the method 500. In other examples, different components of an example device or system that implements the method 500 may perform functions at substantially the same time or in a specific sequence.

According to some embodiments, the method 500 includes block 510 where a data source proxy ML model deployed on an AV receives a set of features selected from raw data for a backbone network of another ML model deployed on the AV. Then, at block 520, the features are utilized as input data to the data source proxy ML model.

Subsequently, at block 530, the data source proxy ML model identifies, based on the input data, a portion of the raw data to classify as mining data. Lastly, at block 540, identification of the portion of the raw data is provided as a data mining output.

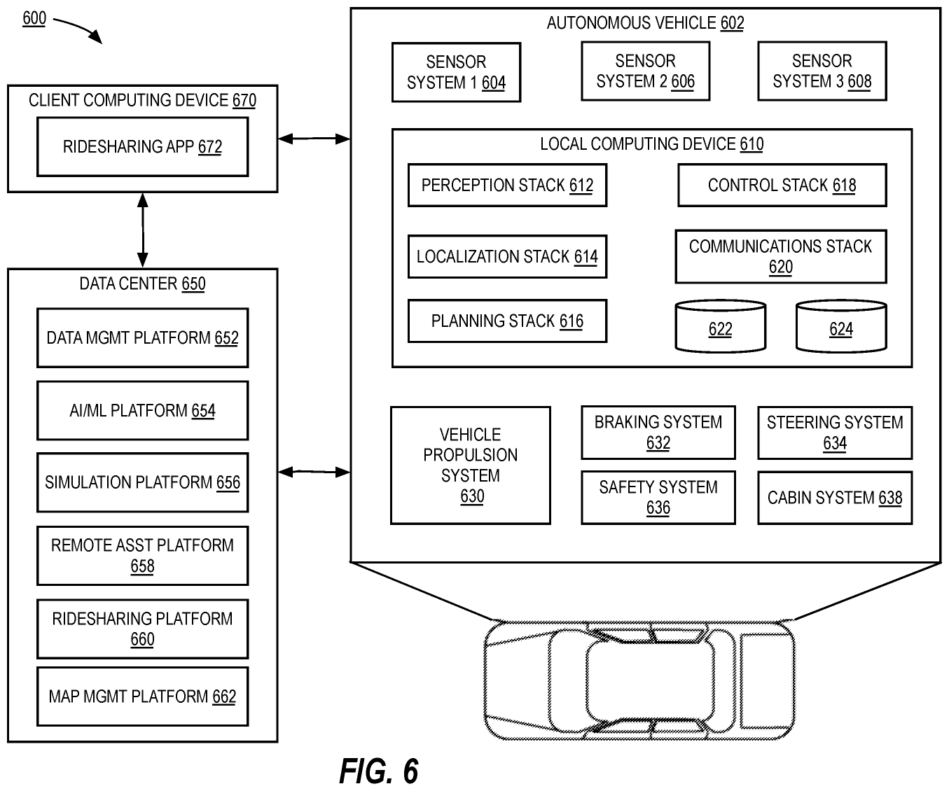

Turning now to FIG. 6, this figure illustrates an example of an AV management system 600. In one embodiment, the AV management system 600 can implement data mining on an edge platform using repurposed neural network models in autonomous systems, as described further herein. One of ordinary skill in the art will understand that, for the AV management system 600 and any system discussed in the disclosure, there can be additional or fewer components in similar or alternative configurations. The illustrations and examples provided in the disclosure are for conciseness and clarity. Other embodiments may include different numbers and/or types of elements, but one of ordinary skill the art will appreciate that such variations do not depart from the scope of the disclosure.

In this example, the AV management system 600 includes an AV 602, a data center 650, and a client computing device 670. The AV 602, the data center 650, and the client computing device 670 can communicate with one another over one or more networks (not shown), such as a public network (e.g., the Internet, an Infrastructure as a Service (IaaS) network, a Platform as a Service (PaaS) network, a Software as a Service (SaaS) network, another Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

AV 602 can navigate about roadways without a human driver based on sensor signals generated by multiple sensor systems 604, 606, and 608. The sensor systems 604-608 can include different types of sensors and can be arranged about the AV 602. For instance, the sensor systems 604-608 can comprise Inertial Measurement Units (IMUs), cameras (e.g., still image cameras, video cameras, etc.), light sensors (e.g., LIDAR systems, ambient light sensors, infrared sensors, etc.). RADAR systems, a Global Navigation Satellite System (GNSS) receiver, (e.g., Global Positioning System (GPS) receivers), audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 604 can be a camera system, the sensor system 606 can be a LIDAR system, and the sensor system 608 can be a RADAR system. Other embodiments may include any other number and type of sensors.

AV 602 can also include several mechanical systems that can be used to maneuver or operate AV 602. For instance, the mechanical systems can include vehicle propulsion system 630, braking system 632, steering system 634, safety system 636, and cabin system 638, among other systems. Vehicle propulsion system 630 can include an electric motor, an internal combustion engine, or both. The braking system 632 can include an engine brake, a wheel braking system (e.g., a disc braking system that utilizes brake pads), hydraulics, actuators, and/or any other suitable componentry configured to assist in decelerating AV 602. The steering system 634 can include suitable componentry configured to control the direction of movement of the AV 602 during navigation. Safety system 636 can include lights and signal indicators, a parking brake, airbags, and so forth. The cabin system 638 can include cabin temperature control systems, in-cabin entertainment systems, and so forth. In some embodiments, the AV 602 may not include human driver actuators (e.g., steering wheel, handbrake, foot brake pedal, foot accelerator pedal, turn signal lever, window wipers, etc.) for controlling the AV 602. Instead, the cabin system 638 can include one or more client interfaces (e.g., Graphical User Interfaces (GUIs), Voice User Interfaces (VUIs), etc.) for controlling certain aspects of the mechanical systems 630-638.

AV 602 can additionally include a local computing device 610 that is in communication with the sensor systems 604-608, the mechanical systems 630-638, the data center 650, and the client computing device 670, among other systems. The local computing device 610 can include one or more processors and memory, including instructions that can be executed by the one or more processors. The instructions can make up one or more software stacks or components responsible for controlling the AV 602; communicating with the data center 650, the client computing device 670, and other systems; receiving inputs from riders, passengers, and other entities within the AV's environment; logging metrics collected by the sensor systems 604-608; and so forth. In this example, the local computing device 610 includes a perception stack 612, a mapping and localization stack 614, a planning stack 616, a control stack 618, a communications stack 620, a High Definition (HD) geospatial database 622, and an AV operational database 624, among other stacks and systems.

Perception stack 612 can enable the AV 602 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 604-608, the mapping and localization stack 614, the HD geospatial database 622, other components of the AV, and other data sources (e.g., the data center 650, the client computing device 670, third-party data sources, etc.). The perception stack 612 can detect and classify objects and determine their current and predicted locations, speeds, directions, and the like. In addition, the perception stack 612 can determine the free space around the AV 602 (e.g., to maintain a safe distance from other objects, change lanes, park the AV, etc.). The perception stack 612 can also identify environmental uncertainties, such as where to look for moving objects, flag areas that may be obscured or blocked from view, and so forth.

Mapping and localization stack 614 can determine the AV's position and orientation (pose) using different methods from multiple systems (e.g., GPS, IMUs, cameras, LIDAR, RADAR, ultrasonic sensors, the HD geospatial database 622, etc.). For example, in some embodiments, the AV 602 can compare sensor data captured in real-time by the sensor systems 604-608 to data in the HD geospatial database 622 to determine its precise (e.g., accurate to the order of a few centimeters or less) position and orientation. The AV 602 can focus its search based on sensor data from one or more first sensor systems (e.g., GPS) by matching sensor data from one or more second sensor systems (e.g., LIDAR). If the mapping and localization information from one system is unavailable, the AV 602 can use mapping and localization information from a redundant system and/or from remote data sources.

The planning stack 616 can determine how to maneuver or operate the AV 602 safely and efficiently in its environment. For example, the planning stack 616 can receive the location, speed, and direction of the AV 602, geospatial data, data regarding objects sharing the road with the AV 602 (e.g., pedestrians, bicycles, vehicles, ambulances, buses, cable cars, trains, traffic lights, lanes, road markings, etc.) or certain events occurring during a trip (e.g., an Emergency Vehicle (EMV) blaring a siren, intersections, occluded areas, street closures for construction or street repairs, Double-Parked Vehicles (DPVs), etc.), traffic rules and other safety standards or practices for the road, user input, and other relevant data for directing the AV 602 from one point to another. The planning stack 616 can determine multiple sets of one or more mechanical operations that the AV 602 can perform (e.g., go straight at a specified speed or rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the one to meet changing road conditions and events. If something unexpected happens, the planning stack 616 can select from multiple backup plans to carry out. For example, while preparing to change lanes to turn right at an intersection, another vehicle may aggressively cut into the destination lane, making the lane change unsafe. The planning stack 616 could have already determined an alternative plan for such an event, and upon its occurrence, help to direct the AV 602 to go around the block instead of blocking a current lane while waiting for an opening to change lanes.

The control stack 618 can manage the operation of the vehicle propulsion system 630, the braking system 632, the steering system 634, the safety system 636, and the cabin system 638. The control stack 618 can receive sensor signals from the sensor systems 604-608 as well as communicate with other stacks or components of the local computing device 610 or a remote system (e.g., the data center 650) to effectuate operation of the AV 602. For example, the control stack 618 can implement the final path or actions from the multiple paths or actions provided by the planning stack 616. This can involve turning the routes and decisions from the planning stack 616 into commands for the actuators that control the AV's steering, throttle, brake, and drive unit.

The communication stack 620 can transmit and receive signals between the various stacks and other components of the AV 602 and between the AV 602, the data center 650, the client computing device 670, and other remote systems. The communication stack 620 can enable the local computing device 610 to exchange information remotely over a network, such as through an antenna array or interface that can provide a metropolitan WIFI® network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communication stack 620 can also facilitate local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 622 can store HD maps and related data of the streets upon which the AV 602 travels. In some embodiments, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane or road centerline, lane boundaries, type of lane boundaries, etc.) and related attributes (e.g., direction of travel, speed limit, lane type, etc.). The lanes and boundaries layer can also include 3D attributes related to lanes (e.g., slope, elevation, curvature, etc.). The intersections layer can include geospatial information of intersections (e.g., crosswalks, stop lines, turning lane centerlines, and/or boundaries, etc.) and related attributes (e.g., permissive, protected/permissive, or protected only left turn lanes; permissive, protected/permissive, or protected only U-turn lanes; permissive or protected only right turn lanes; etc.). The traffic controls layer can include geospatial information of traffic signal lights, traffic signs, and other road objects and related attributes.

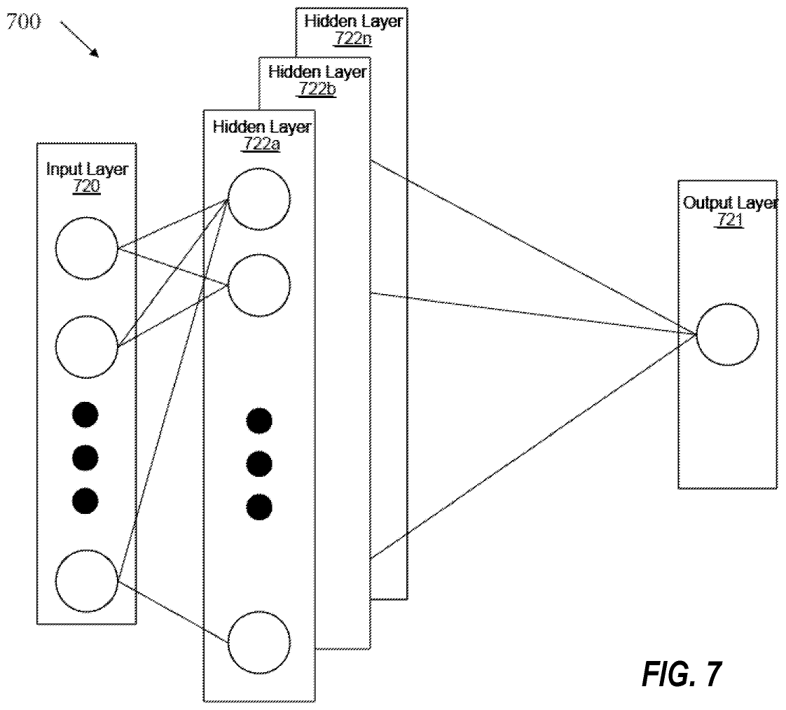

The AV operational database 624 can store raw AV data generated by the sensor systems 604-608 and other components of the AV 602 and/or data received by the AV 602 from remote systems (e.g., the data center 650, the client computing device 670, etc.). In some embodiments, the raw AV data can include HD LIDAR point cloud data, image or video data, RADAR data, GPS data, and other sensor data that the data center 650 can use for creating or updating AV geospatial data as discussed further below with respect to FIG. 7 and elsewhere in the disclosure.

The data center 650 can be a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and so forth. The data center 650 can include one or more computing devices remote to the local computing device 610 for managing a fleet of AVs and AV-related services. For example, in addition to managing the AV 602, the data center 650 may also support a ridesharing service, a delivery service, a remote/roadside assistance service, street services (e.g., street mapping, street patrol, street cleaning, street metering, parking reservation, etc.), and the like.

The data center 650 can send and receive various signals to and from the AV 602 and the client computing device 670. These signals can include sensor data captured by the sensor systems 604-608, roadside assistance requests, software updates, ridesharing pick-up and drop-off instructions, and so forth. In this example, the data center 650 includes one or more of a data management platform 652, an Artificial Intelligence/Machine Learning (AI/ML) platform 654, a simulation platform 656, a remote assistance platform 658, a ridesharing platform 660, and a map management platform 662, among other systems.

Data management platform 652 can be a “big data” system capable of receiving and transmitting data at high speeds (e.g., near real-time or real-time), processing a large variety of data, and storing large volumes of data (e.g., terabytes, petabytes, or more of data). The varieties of data can include data having different structures (e.g., structured, semi-structured, unstructured, etc.), data of different types (e.g., sensor data, mechanical system data, ridesharing service data, map data, audio data, video data, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 650 can access data stored by the data management platform 652 to provide their respective services.

The AI/ML platform 654 can provide the infrastructure for training and evaluating machine learning algorithms for operating the AV 602, the simulation platform 656, the remote assistance platform 658, the ridesharing platform 660, the map management platform 662, and other platforms and systems. Using the AI/ML platform 654, data scientists can prepare data sets from the data management platform 652; select, design, and train machine learning models; evaluate, refine, and deploy the models; maintain, monitor, and retrain the models; and so on.

The simulation platform 656 can enable testing and validation of the algorithms, machine learning models, neural networks, and other development efforts for the AV 602, the remote assistance platform 658, the ridesharing platform 660, the map management platform 662, and other platforms and systems. The simulation platform 656 can replicate a variety of driving environments and/or reproduce real-world scenarios from data captured by the AV 602, including rendering geospatial information and road infrastructure (e.g., streets, lanes, crosswalks, traffic lights, stop signs, etc.) obtained from the map management platform 662; modeling the behavior of other vehicles, bicycles, pedestrians, and other dynamic elements; simulating inclement weather conditions, different traffic scenarios; and so on.

The remote assistance platform 658 can generate and transmit instructions regarding the operation of the AV 602. For example, in response to an output of the AI/ML platform 654 or other system of the data center 650, the remote assistance platform 658 can prepare instructions for one or more stacks or other components of the AV 602.

The ridesharing platform 660 can interact with a customer of a ridesharing service via a ridesharing application 672 executing on the client computing device 670. The client computing device 670 can be any type of computing system, including a server, desktop computer, laptop, tablet, smartphone, smart wearable device (e.g., smart watch; smart eyeglasses or other Head-Mounted Display (HMD); smart ear pods or other smart in-ear, on-car, or over-ear device; etc.), gaming system, or other general purpose computing device for accessing the ridesharing application 672. The client computing device 670 can be a customer's mobile computing device or a computing device integrated with the AV 602 (e.g., the local computing device 610). The ridesharing platform 660 can receive requests to be picked up or dropped off from the ridesharing application 672 and dispatch the AV 602 for the trip.

Map management platform 662 can provide a set of tools for the manipulation and management of geographic and spatial (geospatial) and related attribute data. The data management platform 652 can receive LIDAR point cloud data, image data (e.g., still image, video, etc.), RADAR data, GPS data, and other sensor data (e.g., raw data) from one or more AVs 602, Unmanned Aerial Vehicles (UAVs), satellites, third-party mapping services, and other sources of geospatially referenced data. The raw data can be processed, and map management platform 662 can render base representations (e.g., tiles (2D), bounding volumes (3D), etc.) of the AV geospatial data to enable users to view, query, label, edit, and otherwise interact with the data. Map management platform 662 can manage workflows and tasks for operating on the AV geospatial data. Map management platform 662 can control access to the AV geospatial data, including granting or limiting access to the AV geospatial data based on user-based, role-based, group-based, task-based, and other attribute-based access control mechanisms. Map management platform 662 can provide version control for the AV geospatial data, such as to track specific changes that (human or machine) map editors have made to the data and to revert changes. Map management platform 662 can administer release management of the AV geospatial data, including distributing suitable iterations of the data to different users, computing devices, AVs, and other consumers of HD maps. Map management platform 662 can provide analytics regarding the AV geospatial data and related data, such as to generate insights relating to the throughput and quality of mapping tasks.

In some embodiments, the map viewing services of map management platform 662 can be modularized and deployed as part of one or more of the platforms and systems of the data center 650. For example, the AI/ML platform 654 may incorporate the map viewing services for visualizing the effectiveness of various object detection or object classification models, the simulation platform 656 may incorporate the map viewing services for recreating and visualizing certain driving scenarios, the remote assistance platform 658 may incorporate the map viewing services for replaying traffic incidents to facilitate and coordinate aid, the ridesharing platform 660 may incorporate the map viewing services into the client application 672 to enable passengers to view the AV 602 in transit en route to a pick-up or drop-off location, and so on.

In FIG. 7, the disclosure now turns to a further discussion of models that can be used through the environments and techniques described herein. Specifically, FIG. 7 is an illustrative example of a deep learning neural network 700 that can be used to implement all or a portion of a perception module (or perception system) as discussed above. An input layer 720 can be configured to receive sensor data and/or data relating to an environment surrounding an AV. The neural network 700 includes multiple hidden layers 722a, 722b, through 722n. The hidden layers 722a, 722b, through 722n include “n” number of hidden layers, where “n” is an integer greater than or equal to one. The number of hidden layers can be made to include many layers for the given application. The neural network 700 further includes an output layer 721 that provides an output resulting from the processing performed by the hidden layers 722a, 722b, through 722n. In one illustrative example, the output layer 721 can provide estimated treatment parameters that can be used/ingested by a differential simulator to estimate a patient treatment outcome.

The neural network 700 is a multi-layer neural network of interconnected nodes. Each node can represent a piece of information. Information associated with the nodes is shared among the different layers and each layer retains information as information is processed. In some cases, the neural network 700 can include a feed-forward network, in which case there are no feedback connections where outputs of the network are fed back into itself. In some cases, the neural network 700 can include a recurrent neural network, which can have loops that allow information to be carried across nodes while reading in input.

Information can be exchanged between nodes through node-to-node interconnections between the various layers. Nodes of the input layer 720 can activate a set of nodes in the first hidden layer 722a. For example, as shown, each of the input nodes of the input layer 720 is connected to each of the nodes of the first hidden layer 722a. The nodes of the first hidden layer 722a can transform the information of each input node by applying activation functions to the input node information. The information derived from the transformation can then be passed to and can activate the nodes of the next hidden layer 722b, which can perform their own designated functions. Example functions include convolutional, up-sampling, data transformation, and/or any other suitable functions. The output of the hidden layer 722b can then activate nodes of the next hidden layer, and so on. The output of the last hidden layer 722n can activate one or more nodes of the output layer 721, at which an output is provided. In some cases, while nodes in the neural network 700 are shown as having multiple output lines, a node can have a single output and all lines shown as being output from a node represent the same output value.

In some cases, each node or interconnection between nodes can have a weight that is a set of parameters derived from the training of the neural network 700. Once the neural network 700 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 700 to be adaptive to inputs and able to learn as more and more data is processed.

The neural network 700 is pre-trained to process the features from the data in the input layer 720 using the different hidden layers 722a. 722b, through 722n in order to provide the output through the output layer 721.

In some cases, the neural network 700 can adjust the weights of the nodes using a training process called backpropagation. A backpropagation process can include a forward pass, a loss function, a backward pass, and a weight update. The forward pass, loss function, backward pass, and parameter/weight update is performed for one training iteration. The process can be repeated for a certain number of iterations for each set of training data until the neural network 700 is trained well enough so that the weights of the layers are accurately tuned.

To perform training, a loss function can be used to analyze errors in the output. Any suitable loss function definition can be used, such as a Cross-Entropy loss. Another example of a loss function includes the mean squared error (MSE), defined as E_total=Σ(½(target−output)²). The loss can be set to be equal to the value of E_total.

The loss (or error) will be high for the initial training data since the actual values will be much different than the predicted output. The goal of training is to minimize the amount of loss so that the predicted output is the same as the training output. The neural network 700 can perform a backward pass by determining which inputs (weights) most contributed to the loss of the network, and can adjust the weights so that the loss decreases and is eventually minimized.

The neural network 700 can include any suitable deep network. One example includes a Convolutional Neural Network (CNN), which includes an input layer and an output layer, with multiple hidden layers between the input and out layers. The hidden layers of a CNN include a series of convolutional, nonlinear, pooling (for down sampling), and fully connected layers. The neural network 700 can include any other deep network other than a CNN, such as an autoencoder, Deep Belief Nets (DBNs), Recurrent Neural Networks (RNNs), among others.

As understood by those of skill in the art, machine-learning based classification techniques can vary depending on the desired implementation. For example, machine-learning classification schemes can utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to: a Stochastic Gradient Descent Regressor, a Passive Aggressive Regressor, etc.

Machine learning classification models can also be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor. Additionally, machine-learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

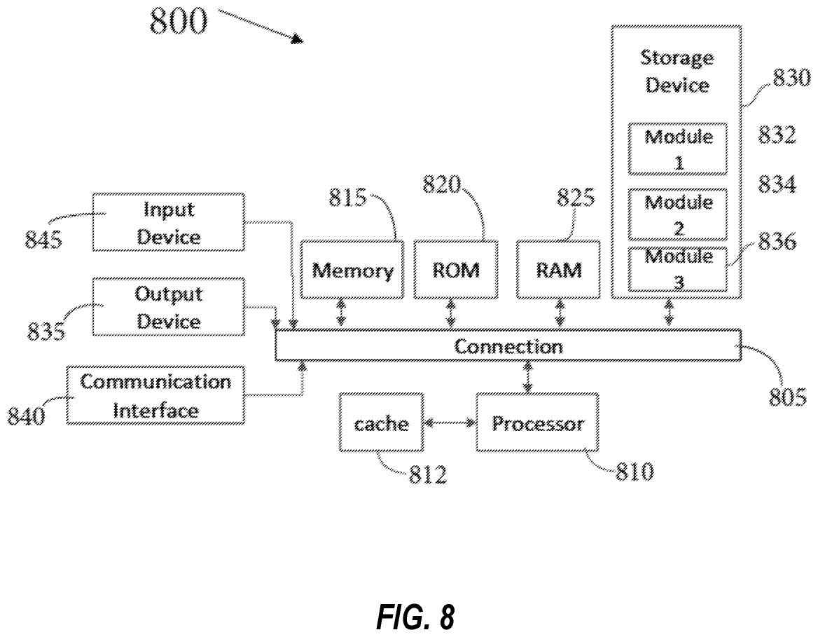

FIG. 8 illustrates an example processor-based system with which some aspects of the subject technology can be implemented. For example, processor-based system 800 can be any computing device making up, or any component thereof in which the components of the system are in communication with each other using connection 805. Connection 805 can be a physical connection via a bus, or a direct connection into processor 810, such as in a chipset architecture. Connection 805 can also be a virtual connection, networked connection, or logical connection.

In some embodiments, computing system 800 is a distributed system in which the functions described in this disclosure can be distributed within a data center, multiple data centers, a peer network, etc. In some embodiments, one or more of the described system components represents many such components each performing some or all of the function for which the component is described. In some embodiments, the components can be physical or virtual devices.

Example system 800 includes at least one processing unit (Central Processing Unit (CPU) or processor) 810 and connection 805 that couples various system components including system memory 815, such as Read-Only Memory (ROM) 820 and Random-Access Memory (RAM) 825 to processor 810. Computing system 800 can include a cache of high-speed memory 812 connected directly with, in close proximity to, or integrated as part of processor 810.

Processor 810 can include any general-purpose processor and a hardware service or software service, such as services 832, 834, and 836 stored in storage device 830, configured to control processor 810 as well as a special-purpose processor where software instructions are incorporated into the actual processor design. Processor 810 may be a completely self-contained computing system, containing multiple cores or processors, a bus, memory controller, cache, etc. A multi-core processor may be symmetric or asymmetric.

To enable user interaction, computing system 800 includes an input device 845, which can represent any number of input mechanisms, such as a microphone for speech, a touch-sensitive screen for gesture or graphical input, keyboard, mouse, motion input, speech, etc. Computing system 800 can also include output device 835, which can be one or more of a number of output mechanisms known to those of skill in the art. In some instances, multimodal systems can enable a user to provide multiple types of input/output to communicate with computing system 800. Computing system 800 can include communications interface 840, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communications interface 840 may also include one or more Global Navigation Satellite System (GNSS) receivers or transceivers that are used to determine a location of the computing system 800 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 830 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Atatic RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L#), Resistive RAM (RRAM/ReRAM), Phase Change Memory (PCM), Spin Transfer Torque RAM (STT-RAM), another memory chip or cartridge, and/or a combination thereof.

Storage device 830 can include software services, servers, services, etc., that when the code that defines such software is executed by the processor 810, it causes the system 800 to perform a function. In some embodiments, a hardware service that performs a particular function can include the software component stored in a computer-readable medium in connection with hardware components, such as processor 810, connection 805, output device 835, etc., to carry out the function.

Embodiments within the scope of the disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

### Selected Examples

Example 1 includes a computer-implemented method for facilitating data mining on an edge platform using repurposed neural network models in autonomous systems, where the method comprises: receiving, by a processing device hosting a data source proxy head of a machine learning (ML) model deployed on an autonomous vehicle (AV), a set of features selected from raw data by a backbone network of the ML model; utilizing, by the data source proxy head, the set of features selected from the raw data as input data to a trained data source mining model of the data source proxy head; identifying, by the trained data source mining model based on the input data, a portion of the raw data to classify as mining data; and providing, by the data source proxy head, identification of the portion of the raw data as a data mining output.

In Example 2, the subject matter of Example 1 can optionally include wherein the ML model comprises a plurality of heads including a primary model head and the data source proxy head. In Example 3, the subject matter of any one of Examples 1-2 can optionally include wherein, during training of the ML model, the data source proxy head and the primary model head are optimized during training at a same time. In Example 4, the subject matter of any one of Examples 1-3 can optionally include wherein, during training of the ML model, the data source proxy head is optimized separately from the primary model head by freezing weights and parameters of the backbone network.

In Example 5, the subject matter of any one of Examples 1-4 can optionally include wherein the trained data source mining model of the data source proxy head is trained separately from the ML model and is to consume the set of features that the ML model consumes without utilizing the backbone network of the ML model. In Example 6, the subject matter of any one of Examples 1-5 can optionally include wherein the data source proxy head is to mitigate regression of the ML model by maintaining a loss weight of the data source proxy head below a determined weight value.

In Example 7, the subject matter of any one of Examples 1-6 can optionally include wherein, during training, the data source proxy head is to bootstrap one or more other data mining models by utilizing data sources of the one or more other data mining models and by leveraging manual user labels. In Example 8, the subject matter of any one of Examples 1-7 can optionally include wherein the ML model comprises a trajectory generation model deployed on the AV. In Example 9, the subject matter of any one of Examples 1-8 can optionally include wherein the data source proxy head implements a classifier model.

Example 10 includes an apparatus for facilitating data mining on an edge platform using repurposed neural network models in autonomous systems, the apparatus of Example 10 comprising one or more hardware processors to: receive, at a data source proxy head of a machine learning (ML) model deployed on an autonomous vehicle (AV) having the one or more hardware processors, a set of features selected from raw data by a backbone network of the ML model; utilize, by the data source proxy head, the set of features selected from the raw data as input data to a trained data source mining model of the data source proxy head; identify, by the trained data source mining model based on the input data, a portion of the raw data to classify as mining data; and provide, by the data source proxy head, identification of the portion of the raw data as a data mining output.

In Example 11, the subject matter of Example 10 can optionally include wherein the ML model comprises a plurality of heads including a primary model head and the data source proxy head. In Example 12, the subject matter of Examples 10-11 can optionally include wherein, during training of the ML model, the data source proxy head and the primary model head are optimized during training at a same time. In Example 13, the subject matter of Examples 10-12 can optionally include wherein, during training of the ML model, the data source proxy head is optimized separately from the primary model head by freezing weights and parameters of the backbone network.

In Example 14, the subject matter of Examples 10-13 can optionally include wherein the trained data source mining model of the data source proxy head is trained separately from the ML model and is to consume the set of features that the ML model consumes without utilizing the backbone network of the ML model. In Example 15, the subject matter of Examples 10-14 can optionally include wherein the data source proxy head is to mitigate regression of the ML model by maintaining a loss weight of the data source proxy head below a determined weight value.

Example 16 is a non-transitory computer-readable storage medium for facilitating data mining on an edge platform using repurposed neural network models in autonomous systems. The non-transitory computer-readable storage medium of Example 16 having stored thereon executable computer program instructions that, when executed by one or more processors, cause the one or more processors to: receive, at a data source proxy head of a machine learning (ML) model deployed on an autonomous vehicle (AV) having the one or more processors, a set of features selected from raw data by a backbone network of the ML model; utilize, by the data source proxy head, the set of features selected from the raw data as input data to a trained data source mining model of the data source proxy head; identify, by the trained data source mining model based on the input data, a portion of the raw data to classify as mining data; and provide, by the data source proxy head, identification of the portion of the raw data as a data mining output.

In Example 17, the subject matter of Example 16 can optionally include wherein the ML model comprises a plurality of heads including a primary model head and the data source proxy head, and wherein, during training of the ML model, the data source proxy head and the primary model head are optimized during training at a same time. In Example 18, the subject matter of Examples 16-17 can optionally include wherein the ML model comprises a plurality of heads including a primary model head and the data source proxy head, and wherein, during training of the ML model, the data source proxy head is optimized separately from the primary model head by freezing weights and parameters of the backbone network.

In Example 19, the subject matter of Examples 16-18 can optionally include wherein the trained data source mining model of the data source proxy head is trained separately from the ML model and is to consume the set of features that the ML model consumes without utilizing the backbone network of the ML model. In Example 20, the subject matter of Examples 16-19 can optionally include wherein the data source proxy head is to mitigate regression of the ML model by maintaining a loss weight of the data source proxy head below a determined weight value.

Example 21 is a system for facilitating data mining on an edge platform using repurposed neural network models in autonomous systems. The system of Example 21 can optionally include a memory to store a block of data, and one or more hardware processors to: receive, at a data source proxy head of a machine learning (ML) model deployed on an autonomous vehicle (AV) having the one or more hardware processors, a set of features selected from raw data by a backbone network of the ML model; utilize, by the data source proxy head, the set of features selected from the raw data as input data to a trained data source mining model of the data source proxy head; identify, by the trained data source mining model based on the input data, a portion of the raw data to classify as mining data; and provide, by the data source proxy head, identification of the portion of the raw data as a data mining output.

In Example 22, the subject matter of Example 21 can optionally include wherein the ML model comprises a plurality of heads including a primary model head and the data source proxy head. In Example 23, the subject matter of Examples 21-22 can optionally include wherein, during training of the ML model, the data source proxy head and the primary model head are optimized during training at a same time. In Example 24, the subject matter of Examples 21-23 can optionally include wherein, during training of the ML model, the data source proxy head is optimized separately from the primary model head by freezing weights and parameters of the backbone network.

In Example 25, the subject matter of Examples 21-24 can optionally include wherein the trained data source mining model of the data source proxy head is trained separately from the ML model and is to consume the set of features that the ML model consumes without utilizing the backbone network of the ML model. In Example 26, the subject matter of Examples 21-25 can optionally include wherein the data source proxy head is to mitigate regression of the ML model by maintaining a loss weight of the data source proxy head below a determined weight value.

Example 27 includes an apparatus comprising means for performing the method of any of the Examples 1-9. Example 28 is at least one machine readable medium comprising a plurality of instructions that in response to being executed on a computing device, cause the computing device to carry out a method according to any one of Examples 1-9. Example 29 is an apparatus for facilitating data mining on an edge platform using repurposed neural network models in autonomous systems, configured to perform the method of any one of Examples 1-9. Specifics in the Examples may be used anywhere in one or more embodiments.

The various embodiments described above are provided by way of illustration and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure. Claim language reciting “at least one of” a set indicates that one member of the set or multiple members of the set satisfy the claim.

What is claimed is:

1. A computer implemented method comprising:
receiving, by a processing device hosting a data source proxy head of a machine learning (ML) model deployed on an autonomous vehicle (AV), a set of features selected from raw data by a backbone network of the ML model;
utilizing, by the data source proxy head, the set of features selected from the raw data as input data to a trained data source mining model of the data source proxy head;
identifying, by the trained data source mining model based on the input data, a portion of the raw data to classify as mining data; and
providing, by the data source proxy head, identification of the portion of the raw data as a data mining output.

2. The computer implemented method of claim 1, wherein the ML model comprises a plurality of heads including a primary model head and the data source proxy head.

3. The computer implemented method of claim 2, wherein, during training of the ML model, the data source proxy head and the primary model head are optimized during training at a same time.

4. The computer implemented method of claim 2, wherein, during training of the ML model, the data source proxy head is optimized separately from the primary model head by freezing weights and parameters of the backbone network.

5. The computer implemented method of claim 1, wherein the trained data source mining model of the data source proxy head is trained separately from the ML model and is to consume the set of features that the ML model consumes without utilizing the backbone network of the ML model.

6. The computer implemented method of claim 1, wherein the data source proxy head is to mitigate regression of the ML model by maintaining a loss weight of the data source proxy head below a determined weight value.

7. The computer implemented method of claim 1, wherein, during training, the data source proxy head is to bootstrap one or more other data mining models by utilizing data sources of the one or more other data mining models and by leveraging manual user labels.

8. The computer implemented method of claim 1, wherein the ML model comprises a trajectory generation model deployed on the AV.

9. The computer implemented method of claim 1, wherein the data source proxy head implements a classifier model.

10. An apparatus comprising:
one or more hardware processors to:
receive, at a data source proxy head of a machine learning (ML) model deployed on an autonomous vehicle (AV) having the one or more hardware processors, a set of features selected from raw data by a backbone network of the ML model;
utilize, by the data source proxy head, the set of features selected from the raw data as input data to a trained data source mining model of the data source proxy head;
identify, by the trained data source mining model based on the input data, a portion of the raw data to classify as mining data; and
provide, by the data source proxy head, identification of the portion of the raw data as a data mining output.

11. The apparatus of claim 10, wherein the ML model comprises a plurality of heads including a primary model head and the data source proxy head.

12. The apparatus of claim 11, wherein, during training of the ML model, the data source proxy head and the primary model head are optimized during training at a same time.

13. The apparatus of claim 11, wherein, during training of the ML model, the data source proxy head is optimized separately from the primary model head by freezing weights and parameters of the backbone network.

14. The apparatus of claim 10, wherein the trained data source mining model of the data source proxy head is trained separately from the ML model and is to consume the set of features that the ML model consumes without utilizing the backbone network of the ML model.

15. The apparatus of claim 10, wherein the data source proxy head is to mitigate regression of the ML model by maintaining a loss weight of the data source proxy head below a determined weight value.

16. A non-transitory computer-readable medium having stored thereon instructions that, when executed by one or more processors, cause the one or more processors to:
receive, at a data source proxy head of a machine learning (ML) model deployed on an autonomous vehicle (AV) having the one or more processors, a set of features selected from raw data by a backbone network of the ML model;
utilize, by the data source proxy head, the set of features selected from the raw data as input data to a trained data source mining model of the data source proxy head;
identify, by the trained data source mining model based on the input data, a portion of the raw data to classify as mining data; and
provide, by the data source proxy head, identification of the portion of the raw data as a data mining output.

17. The non-transitory computer-readable medium of claim 16, wherein the ML model comprises a plurality of heads including a primary model head and the data source proxy head, and wherein, during training of the ML model, the data source proxy head and the primary model head are optimized during training at a same time.

18. The non-transitory computer-readable medium of claim 16, wherein the ML model comprises a plurality of heads including a primary model head and the data source proxy head, and wherein, during training of the ML model, the data source proxy head is optimized separately from the primary model head by freezing weights and parameters of the backbone network.

19. The non-transitory computer-readable medium of claim 16, wherein the trained data source mining model of the data source proxy head is trained separately from the ML model and is to consume the set of features that the ML model consumes without utilizing the backbone network of the ML model.

20. The non-transitory computer-readable medium of claim 16, wherein the data source proxy head is to mitigate regression of the ML model by maintaining a loss weight of the data source proxy head below a determined weight value.
